(19) United States
(12) Patent Application Publication
(10) Pub. No.: US 2007/0113189 A1
(43) Pub. Date: May 17, 2007

(54) Specifying per theme styles for custom graphical elements

(75) Inventors: Sundaram Ramani, Redmond, WA (US); Benjamin Carter, Redmond, WA (US); Robert Ingebretsen, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/274,808

(22) Filed: Nov. 15, 2005

(51) Int. Cl. G06F 17/00

(52) U.S. Cl. 715/746

(57) ABSTRACT

Theme changes for a custom graphical element are facilitated by providing a mechanism for storing theme specific data for the custom graphical element, providing a software object, independent of the custom graphical element, that monitors theme change events and, in response to a new theme being selected, the software object causing the custom graphical element to be redrawn according to the new theme. The custom graphical element may be graphical portions of a custom control, or a custom control itself. Switching to a new theme for an integrated graphical unit may be provided by marking for redrawing all of the graphical elements of the integrated graphical unit, traversing the elements, and redrawing each element that is marked. There may be provided a directory of theme files and, in each theme file, theme specific information indicating visual appearance of graphical elements.

### BACKGROUND

Computer software applications may employ a graphical interface that facilitates user input and output. For example, an application may present a user with one or more windows representing different functional aspects of an application and/or representing different data that may be operated upon by the application. In addition, multiple applications may be present on a computer screen at the same time where the different applications are provided in different windows. Such operating systems also provide users with various options for inputting data including typing on the keyboard and using a mouse to click on menus, scrollbars, buttons, etc.

Although theoretically it is possible to have each application developer write all of the code necessary to present the user with a number of graphical elements, it is more often the case that the application developer uses tools for providing the graphical elements in connection with developing the application. The tools may be in the form of API calls made by the application code to present the various graphical elements and to receive user input through various graphic controls. The tools may be considered part of a presentation system which may be provided by the vendor of the operating system and/or by a third-party. The tools facilitate development of applications by eliminating the need for each application developer to reconstruct the code necessary to provide the graphical elements. In addition, the tools helped to maintain a consistency of presentation for the graphical elements across different applications provided by different developers.

Some presentation systems provide a plurality of stock graphical elements, including graphical controls, that an application developer may use to facilitate user input to an application. Examples of stock graphical controls include menus, scrollbars, and buttons. In addition, some operating systems allow for multiple themes that a user may select to modify the overall look of the user's system. When a user selects a new theme, appropriate modification is made to each of the graphical elements presented to user so that the graphical elements are automatically redrawn without the need for any additional user input and without the need for the application developer to have to provide specific code to facilitate redrawing of the graphical elements when the theme changes. For example, a user selecting a new theme may cause the look of individual windows on a user screen to change without the application developer having had to provide any code to anticipate or account for theme changes. This is because the redrawing of the stock graphical elements is handled by the presentation system.

In many instances, stock controls, such as buttons or menus, may be redrawn in response to a theme change. However, an application developer may wish to provide custom controls that are not otherwise available through the presentation system. Since the custom controls are not provided by the presentation system, there may be no built-in mechanism to facilitate automatic modification of the graphical elements of the custom controls in response to a theme change. Of course, the application developer could provide additional custom code that causes the custom graphical elements to change in response to a theme change, but it would be desirable for a number of reasons to have custom graphical elements be redrawn automatically in the same way that stock graphical elements are automatically redrawn.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The system described herein facilitates theme changes for a custom graphical element by providing a mechanism for storing theme specific data for the custom graphical element, providing a software object, independent of the custom graphical element, that monitors theme change events and, in response to a new theme being selected, the software object causing the custom graphical element to be redrawn according to the new theme. The custom graphical element may be graphical portions of a custom control, or a custom control itself.

The system described herein provides for switching to a new theme for an integrated graphical unit by marking for redrawing all of the graphical elements of the integrated graphical unit, traversing the elements, and redrawing each element that is marked. At least one of the elements may be a custom graphical element, such as graphical portions of a custom control, or a custom control itself.

The system described herein provides theme specific data for representing graphical elements accessing a list of collections, specific to a particular theme, and providing, in each collection, theme specific information indicating visual appearance of graphical elements. There are many possible implementations, including, for example, an implementation where a directory of theme files is provided and the theme specific information is provided in each file. Of course, other implementations are also possible.

### DESCRIPTION OF THE DRAWINGS

FIG. 1 is a diagram illustrating a presentation system, an application, theme data, and resource dictionary data according to an embodiment of the system described herein.

FIG. 2 is a diagram showing an integrated graphical unit that includes a window frame, a title bar, a stock control, and a custom control to illustrate an embodiment of the system described herein.

FIG. 3 is a flowchart illustrating processing performed by a presentation system in response to a theme change according to an embodiment of the system described herein.

FIG. 4 is a flowchart illustrating traversing elements of a graphical tree and marking the elements for redrawing for an integrated graphical unit according to an embodiment of the system described herein.

FIG. 5 is a diagram illustrating a theme directory and theme files according to an embodiment of the system described herein.

FIG. 6 is a diagram illustrating a resource dictionary according to an embodiment of the system described herein.

FIG. 7 is a flowchart illustrating redrawing a screen in response to a theme change according to an embodiment of the system described herein.

FIG. 8 is a flowchart illustrating accessing theme files and resource dictionaries to redraw a graphical element according to an embodiment of the system described herein.

### DETAILED DESCRIPTION

Described herein are various technologies and techniques for facilitating automatic handling of theme changes for custom graphical elements, such as the graphical portion of custom controls. Various embodiments are described more fully below with reference to the accompanying drawings, which form a part hereof, and which show specific exemplary embodiments for practicing various embodiments. However, other embodiments may be implemented in many different forms and should not be construed as limited to the embodiments set forth herein; rather, these embodiments are provided so that this disclosure will be thorough and complete. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

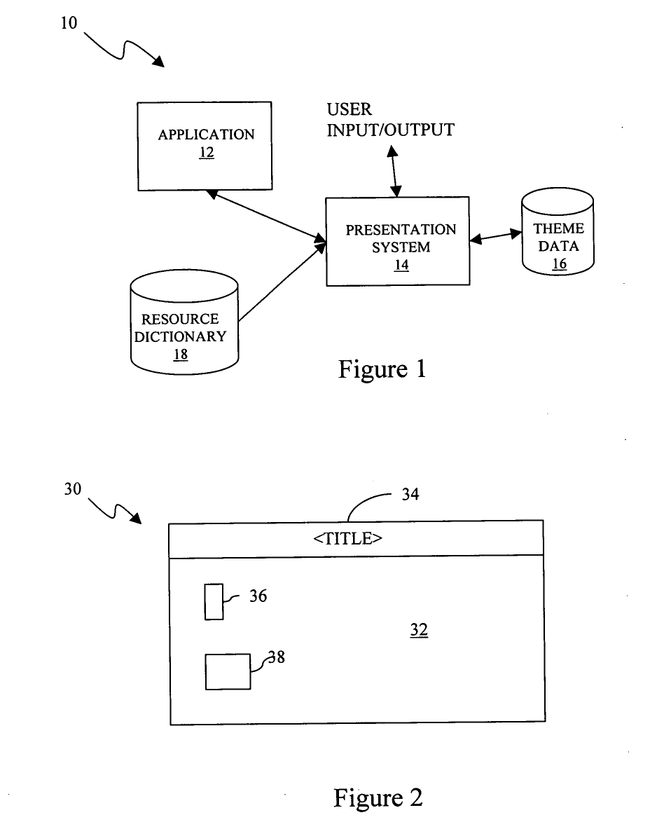

Referring to FIG. 1, a diagram 10 illustrates a plurality of system components including an application 12, a presentation system 14, theme data 16, and a resource dictionary data element 18. The application 12 represents any appropriate application that operates, at least in part, by presenting information to user and/or receiving input from a user. The application 12 interacts (e.g., by API calls) with the presentation system 14 to facilitate user input and output to and from the application 12. Except as described elsewhere herein, the presentation system 14 may be any conventional presentation system used to provide appropriate functionality to the application 12 to allow for user input and output. For example, the presentation system 14 may draw window frames, menus, etc. and receive and pass on to the application user input in the form of typed keys, mouse clicks, etc.

The theme data 16 may include data indicative of the currently selected theme. For example, there may be a theme called “classic” that the user has selected and there may be data provided in the theme data 16 indicating that the user has selected the classic theme. In an embodiment herein, the user may select a theme for his computer system that remains in effect unless and until the user changes the theme. The resource dictionary data element 18 contains information, on a per theme basis, that allows the presentation system 14 to draw various graphical elements. Note that having the resource dictionary data element 18 be separate from the application 12 and separate from the presentation system 14 allows for separately and independently defining the appearance of any graphical element handled by the presentation system 14. Thus, for example; for stock elements of the presentation system 14 such as stock menus, it is possible to independently change the appearance of menus for one or more themes by modifying the resource dictionary data element 18 without having to modify the application 12 or having to modify the presentation system 14. The system described herein allows for this mechanism to be extended to custom graphical elements, such as custom graphical elements used with custom controls, that are defined by an application developer.

Referring to FIG. 2, an integrated graphical unit 30 includes graphical elements presented to a user by the presentation system 14 at the direction of the application 12. In the integrated graphical unit 30 of the example of FIG. 2, the user is presented with a window frame 32 having a title bar 34, a stock control 36, and a custom control 38. The presentation system 14 provides the graphical elements 32, 34, 36, 38 in response to the application 12 making an appropriate call to the presentation system 14. For example, the window frame 32 may be provided in response to the application 12 making a call to the presentation system 14 indicating that a window frame is to be drawn and indicating the dimensions and location of the window frame 32. The title bar 34 may be provided in connection with the same code that creates the window frame 32 or may be handled separately.

In an embodiment herein, an integrated graphical unit includes any collection of graphical elements, such as a window and associated elements that may be presented to a user. Elements of an integrated graphical unit may be stored in a data structure (e.g., a tree) containing information indicative of each of the graphical elements (e.g., leaves of the tree). Thus, the integrated graphical unit 30 may be represented by a tree data structure having, as elements, data indicative of the window frame 32, the title bar 34, the stock control 36, and the custom control 38. Of course, other data structures and indeed other mechanisms may be used to maintain information for an integrated graphical unit.

The presentation system 14 may handle a theme changed by monitoring for theme change events and taking appropriate action in response thereto. In an embodiment herein, the presentation system 14 may be implemented using any appropriate computer programming language or system capable of providing the functionality described herein including, for example, a plurality of C++ objects where at least one of the objects includes an event handler that responds to theme change events. The object that monitors theme changes may be provided with the presentation handler 14 and thus may be independent of any custom graphical elements provided by a developer. The developer may provide, for example, a custom control having one or more custom graphical elements associated therewith, and not have to provide any code to handle theme changes.

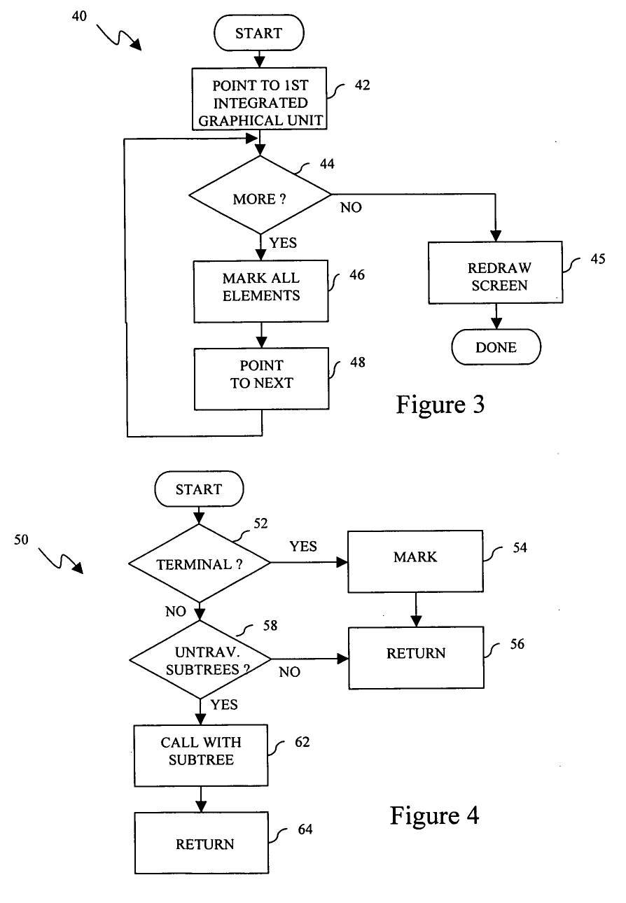

Referring to FIG. 3, a flowchart 40 illustrates a possible event handler for theme change events. As discussed elsewhere herein, the event handler may be part of the presentation system 14 and may be independent of any custom graphical elements provided by a developer. Processing begins at a first step 42 where a pointer for iterating through each integrated graphical unit is made to point to a first integrated graphical unit. Following the step 42 is a test step 44 where it is determined if there are more integrated graphical units to be processed. If not, then control transfers from the test step 44 to a step 45 where the entire screen is redrawn according to the new theme. Redrawing the screen at the step 45 is described in more detail elsewhere herein. Following the step 45, processing is complete.

If it is determined at the test step 44 that there are more integrated graphical units to process, then control transfers from the test step 44 to a step 46 where each of the graphical elements of the particular integrated graphical unit being processed is marked for redrawing. In an embodiment herein, each of the graphical elements includes a flag that indicates whether or not the particular element needs to be redrawn the next time the system redraws the element. Of course, any appropriate mechanism may be used to cause the graphical elements to be redrawn. Following the step 46 is a step 48 where the pointer that points to each of the integrated graphical units is incremented. Following the step 48, control transfers back to the test step 44, described above.

Referring to FIG. 4, a flowchart 50 illustrates in more detail processing performed at the step 46 of the flowchart 40 of FIG. 3 where are elements of an integrated graphical unit are marked for redrawing. In the example illustrated by the flowchart 50, it is assumed that the elements of an integrated graphical unit are interconnected using a tree data structure. However, as discussed elsewhere herein, any appropriate mechanism for maintaining the graphical elements of an integrated graphical unit may be used, including, without limitation, an array, a linked list, and/or a two dimensional array or linked list. Thus, the processing illustrated by the flowchart 50 may be adjusted appropriately depending on the particular data structure or data representation that is used.

Processing for the flowchart 50 begins at a first test step 52 where it is determined if the node/graphical element being pointed to is a terminal node (terminal leaf) of the tree data structure. If so, then control transfers from the test step 52 to a step 54 where the graphical element is marked for redrawing. Following the step 54 is a step 56 where the routine illustrated by the flowchart 50 returns to the calling routine.

If it is determined at the test step 52 that the node passed to the routine is not a terminal node, then control transfers from the test step 52 to a test step 58 which determines if the node contains any untraversed subtrees. The test at the step 58 may be performed, for example, by determining if the first subtree element has been marked or not. If it is determined at the test step 58 that the element passed to the routine represented by the flowchart 50 does not have any untraversed subtree elements, then control transfers from the test step 58 to the step 56, discussed above. Otherwise, control transfers from the test step 58 to a step 62 where the routine illustrated by the flowchart 50 calls itself by passing a pointer to an untraversed subtree node. Thus, the routine illustrated by the flowchart 50 is a recursive routine for traversing a tree and marking all the elements thereof. Following the step 62 is a step 64 where the routine illustrated in the flowchart 50 returns to the calling routine (possibly itself).

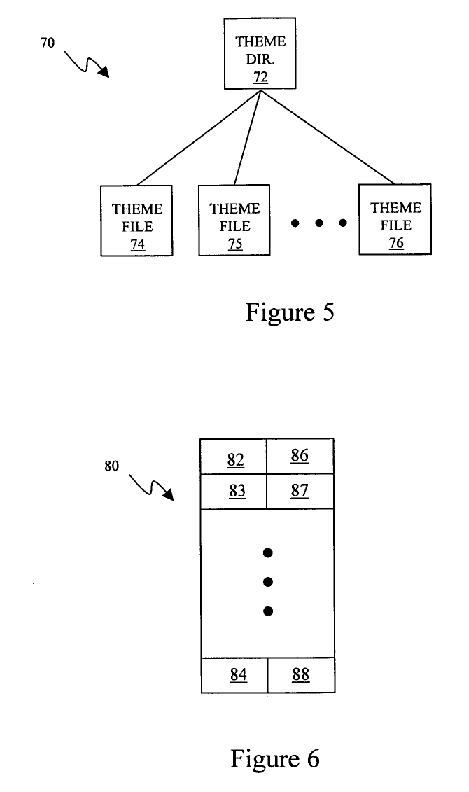

Referring to FIG. 5, a diagram 70 illustrates a mechanism for providing the resource dictionary data element 18 illustrated by the diagram 10 of FIG. 1. The diagram 70 illustrates a theme directory 72 and a plurality of theme files 74-76. The theme directory 72 may be provided in any appropriate location on a computer or other processing device that is used to construct the application 12 and/or to run the application. Of course, the theme directory 72 may be provided in different forms and in different locations such as accessible Web pages and/or as part of an application's assembly. When the application 12 is compiled by the developer, the theme files 74-76 may also be compiled or at least translated to a different form that allows for more efficient use. Any appropriate file format(s) and/or file types may be used. For example, a markup representation such as XAML may be used and the XAML files may, or may not, be subsequently converted into a binary or other format. In other embodiments, the theme files 74-76 may be maintained in a single file format throughout.

In an embodiment herein, each of the theme files 74-76 represents a particular theme (e.g., “classic”) and the contents of each of the theme files 74-76 include entries for each graphical element that may be modified in response to a theme change. Thus, an application developer could create code for a new type of control and could then populate each of the theme files 74-76 with data indicating how the new type of control should look for each of the themes.

Referring to FIG. 6, a table 80 illustrates a possible implementation of a resource dictionary provided in one of the theme files 74-76. The table 80 includes a plurality of index entries 82-84, each of which represents a particular type of graphical element including, possibly, graphical elements associated with a user defined control. The table 80 also includes a plurality of information entries 86-88, each of which corresponds to one of the index entries 82-84. Thus, for example, the information entry 86 corresponds to the index entry 82, the information entry 87 corresponds to the index entry 83, etc. Each of the information entries 86-88 contains visual information about the appearance of a corresponding one of the graphical elements represented by each of the index entries 82-84. The information entries 86-88 may be implemented using any appropriate means including providing data or pointers to data that uses any one of a number of possible formats for representing graphical data (e.g., bitmap data, jpeg data, etc.).

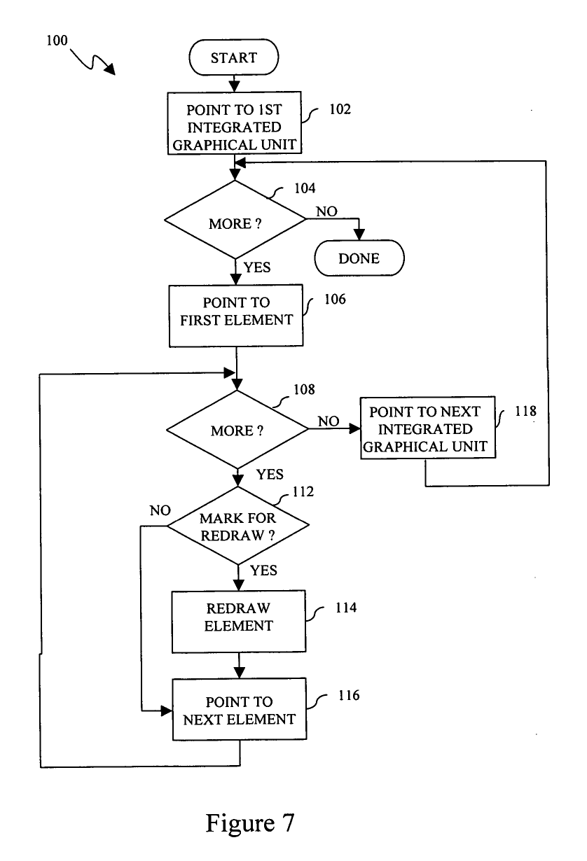

Referring to FIG. 7, a flowchart 100 illustrate steps performed in connection with redrawing the entire screen at the step 45 of the flowchart 40 of FIG. 3. Processing begins at a first step 102 where a pointer that iterates through each of the integrated graphical units of the screen (e.g., iterates through all of the windows shown on a screen) is made to point to the first integrated graphical unit of the screen. In some embodiments, the ordering of the integrated graphical units provided on the screen may be random. In other embodiments, the ordering may be provided such that, for example, the front most integrated graphical unit is the first one, the next front most integrated graphical unit is the second one, and so forth.

Following the first step is a test step 104 which determines if there are more integrated graphical units to processed. The test at the step 104 essentially determines if all of the integrated graphical units have been processed. If so (i.e., there are no more to be processed), then processing is complete. Otherwise, control transfers from the test step 104 to a step 106 were a pointer is made to point in the first graphical element of the integrated graphical unit. Following the step 106 is a test step 108 where it is determined if there are more graphical elements for the integrated graphical unit to be processed.

If it is determined at the test step 108 that there are more graphical elements to be processed for the integrated graphical unit, then control transfers from the test step 108 to a test step 112 where it is determined if the particular graphical element being processed has been marked for redrawing. If so, then control transfers from the test step 112 to a step 114 were the element is redrawn. Redrawing the element at the step 114 is described in more detail elsewhere herein. Following the step 114 is a step 116 where the pointer that iterates through the graphical elements is made to point to the next element of the integrated graphical unit. Note that the step 116 is also reached from the test step 112 if the particular element is not marked for redrawing. Following the step 116, control transfers back to the step 108, discussed above.

If it is determined at the test step 108 that there are no more graphical elements to be processed for the integrated graphical unit, then control transfers from the test step 108 to a step 118 where a pointer that iterates through the integrated graphical units is made to point to the next integrated graphical unit. Following the step 118, control transfers back to the test step 104, discussed above.

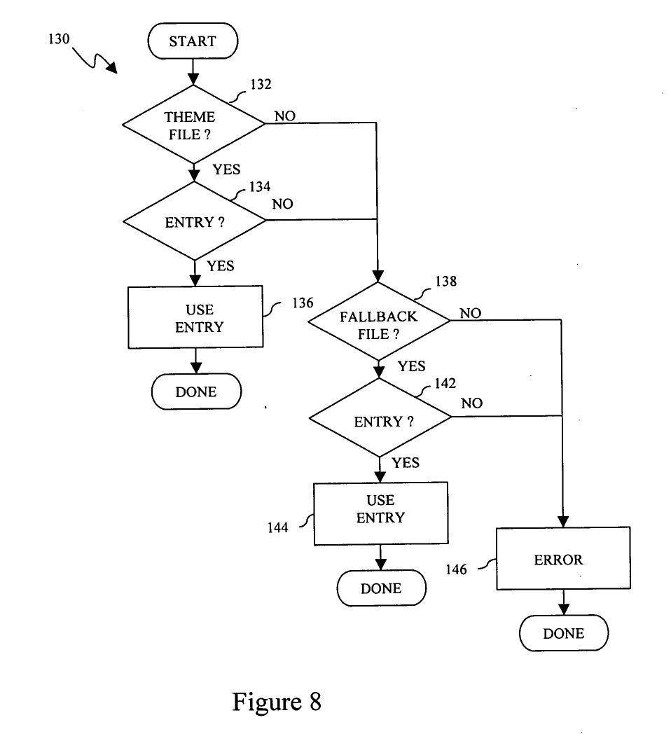

Referring to FIG. 8, a flowchart 130 illustrates in more detail steps performed in connection with the redraw element step 114 of the flowchart 100 of FIG. 7. Processing begins at a first test step 132, where it is determined if one of the theme files 74-76 in the theme directory 72 corresponds to the current theme value indicated by the theme data 16. In an embodiment herein, a convention may be used where the names of the theme files are provided as follows:
<theme name>.<color variant>.xaml
where <theme name> is the name of the theme and <color variant> represents one of the possible colors for the theme. In some embodiments, each theme may have more than one color variant. Of course, any other appropriate mechanism may be used to correlate theme names with theme files (theme data) so that, for any given theme name, it is possible to locate the resource directory (or other type of graphical data indicator) that indicates how each graphical element should be drawn for a particular theme.

If it is determined at the test step 132 that an appropriate theme file exists, then control transfers from the test step 132 to a test step 134 to determine if there is an entry for the particular graphical element being drawn. Note that, in some cases, it is possible for a theme file to exist but for the theme file to not contain an entry corresponding to each and every graphical element that may be drawn. If it is determined at the test step 134 that an entry does exist in the resource dictionary and the theme file, then control transfers from the test step 134 to a step 136 where the entry is used to draw the graphical element. Following the step 136, processing is complete.

If it is determined at the test step 132 that the theme file is not available (e.g., does not exist) or if it is determined at the test step 134 that there is no entry for the particular graphical element being drawn, then control passes from the test step 132 or the test step 134 to a test step 138 where it is determined if there is a fallback theme file that may be used. In an embodiment herein, if a specified theme is not available, there may be at least one fallback theme that may be used. For example, if a particular theme file or entry in the theme file is not available, the system may use a generic theme for a fallback theme. Note also that it is also possible to have multiple fallback themes and that, in some instances, it may be useful to override any new themes set for a graphical element to restore default themes.

If it is determined at the test step 138 that the fallback theme file exists, then control passes from the test step 138 to a test step 142 which determines if an appropriate entry for the graphical element is provided in the fallback theme file. If so, then control transfers from the test step 142 to a step 144 where the entry for the graphical element in the fallback theme file is used. Following the step 144, processing is complete. If it is determined at the test step 138 that there is no fallback theme file, or if it is determined at the test at 142 that there is no entry for the particular graphical element in the fallback theme file, then control transfers to the step 146 where error processing is performed. The error processing performed at the step 146 may include, for example, providing an error message to the user and/or drawing a default graphical element indicating the error. Following the step 146, processing is complete.

The operations described herein may be referred to variously as steps, operations, structural devices, acts or modules. However, it is noted that these operations, structural devices, acts and modules may be implemented in software, in firmware, in special purpose digital logic, a computer readable medium having computer executable instructions, and any combination thereof without deviating from the spirit and scope of the system described herein. Furthermore, it should be appreciated that while a particular order of operation is set forth with respect to the logical operations illustrated herein, other orders of operation are possible, unless indicated otherwise or apparent from the context.

Note also that although the system described herein is described in connection with facilitating theme changes for graphical portions of custom controls provided by an application developer, it is straightforward to extend the system to facilitate theme changes for any custom graphical element that may be provided by an application developer.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of facilitating theme changes for a custom graphical element, comprising:
providing a mechanism for storing theme specific data for the custom graphical element;
providing a software object, independent of the custom graphical element, that monitors theme change events; and
in response to a new theme being selected, the software object causing the custom graphical element to be redrawn according to the new theme.

2. A method, according to claim 1, wherein the custom graphical element is graphical portions of a custom control.

3. A method, according to claim 1, wherein providing a mechanism for storing theme specific data includes providing a directory containing a plurality of theme files.

4. A method, according to claim 3, wherein each of the theme files corresponds to a particular theme.

5. A method, according to claim 3, wherein each of the theme files is a resource dictionary containing entries indicating visual appearance of graphical elements according to a particular theme.

6. A method, according to claim 1, further comprising:
in response to there being no specific information indicating visual appearance of the custom graphical element according to the new theme, redrawing the custom graphical element according to a fallback theme.

7. A method, according to claim 1, wherein the custom graphical element is part of an integrated graphical unit.

8. A method, according to claim 7, wherein the integrated graphical unit corresponds to a window.

9. A computer readable medium having computer executable instructions for performing the steps recited in claim 1.

10. A system having at least one processor that performs the steps recited in claim 1.

11. A method of switching to a new theme for an integrated graphical unit, comprising:
marking for redrawing all of the graphical elements of the integrated graphical unit;
traversing the elements; and
redrawing each element that is marked.

12. A method, according to claim 11, wherein at least one of the elements is a custom graphical element.

13. A method, according to claim 12, wherein at least one of the custom graphical elements is graphical portions of a custom control.

14. A method, according to claim 11, wherein redrawing each element includes accessing theme specific data.

15. A method, according to claim 14, wherein the theme specific data includes a directory containing a plurality of theme files and wherein each of the theme files corresponds to a particular theme.

16. A method, according to claim 14, wherein each of the theme files is a resource dictionary containing entries indicating visual appearance of elements according to a particular theme.

17. A computer readable medium having computer executable instructions for performing the steps recited in claim 11.

18. A system having at least one processor that performs the steps recited in claim 11.

19. A method of providing theme specific data for representing graphical elements, comprising:
providing a directory of theme files; and
providing, in each theme file, theme specific information indicating visual appearance of graphical elements.

20. A method, according to claim 19, further comprising:
in response to there not being theme specific data for a particular graphical element for a particular theme, using data from a fallback theme for the particular graphical element.
